(19) United States
(12) Patent Application Publication
(10) Pub. No.: US 2021/0023639 A1
(43) Pub. Date: Jan. 28, 2021

(54) METHOD AND SYSTEM FOR PIPELINE WELDING

(71) Applicant: WORLDWIDE MACHINERY, LTD., Houston, TX (US)

(72) Inventors: J. EVAN GREENBERG, HOUSTON, TX (US); GREGG RICHARD BRUINSMA, ALBERTA (CA)

(73) Assignee: WORLDWIDE MACHINERY, LTD., Houston, TX (US)

(21) Appl. No.: 16/936,731

(22) Filed: Jul. 23, 2020

Related U.S. Application Data
(60) Provisional application No. 62/877,552, filed on Jul. 23, 2019.

(51) Int. Cl. B23K 9/028; B23K 9/095

(52) U.S. Cl. CPC B23K 9/0286; B23K 9/0956

(57) ABSTRACT

A method is disclosed. The method includes disposing an automated welding device adjacent to a pipe joint and welding an open root pass via the automated welding device using the predefined welding process, wherein the predefined welding process is configured to control a welding arc in response to a short circuit condition. A secondary welding process can be overlaid on the predefined welding process by cycling welding parameter of the predefined welding process can be cycled between a high parameter value and a low parameter value about a base parameter value. Further, an arc between the automated welding device and the pipe joint can be maintained during welding. Because the welding parameter is cycled between a high and low parameter value, the automated welding device can deliver consistent successful welds.

### RELATED APPLICATIONS

This application claims priority to U.S. Provisional Application Ser. No. 62/877,552, filed, Jul. 23, 2019, entitled “METHOD AND SYSTEM FOR PIPELINE WELDING,” which is incorporated by reference herein in its entirety.

### TECHNICAL FIELD

The present disclosure relates generally to pipeline welding systems and methods of use thereof, and more particularly, to automated pipeline welding systems and methods of use thereof.

### BACKGROUND

Pipelines facilitate the transportation of liquids and/or gases through a system of pipes. Pipelines can be formed from steel pipes or tubes that are joined together. Pipes are often welded together to form connections therebetween. Pipelines can be welded manually or using automated devices.

During the welding of pipelines, the root pass or initial welding pass joins the two pipes together. However, one drawback of conventional welding techniques is that liquefied metal may migrate past the joint and into the pipe during the root pass, compromising the quality of the weld and potentially damaging the pipe.

In certain applications, clamps disposed within the pipe to prevent the dripping and migration of liquid metal. Some clamps may utilize copper pads to prevent liquefied metal from migrating past the joint. However, the use of clamps and/or copper pads may be prevented by regulatory bodies. Therefore, what is needed is an apparatus, system or method that addresses one or more of the foregoing issues, among one or more other issues.

### SUMMARY OF THE INVENTION

A method is disclosed. The method includes disposing an automated welding device adjacent to a pipe joint and welding an open root pass via the automated welding device using the predefined welding process, wherein the predefined welding process is configured to control a welding arc in response to a short circuit condition. A secondary welding process can be overlaid on the predefined welding process by cycling welding parameter of the predefined welding process can be cycled between a high parameter value and a low parameter value about a base parameter value. Further, an arc between the automated welding device and the pipe joint can be maintained during welding. Because the welding parameter is cycled between a high and low parameter value, the automated welding device can deliver consistent successful welds.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 is a schematic view of an automated welding system.

FIG. 2 is a cross-sectional schematic view of the automated welding device of FIG. 1.

FIG. 3 is a partial cross-sectional view of a pipe joint.

FIG. 4 is a chart illustrating cycling a welding parameter.

FIGS. 5-13 are photographs of an automated welding system, according to some embodiments.

FIGS. 14 and 15 are photographs of a pipe joint, according to some embodiments.

### DETAILED DESCRIPTION

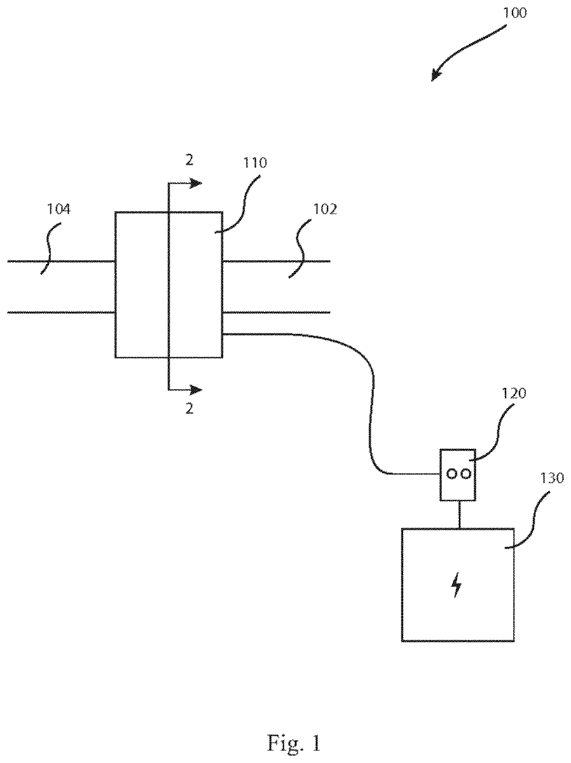

FIG. 1 is a schematic view of an automated welding system 100. In the depicted example, the automated welding system 100 can be used to weld pipe joints between multiple pipes 102 and 104. In some embodiments, the pipes 102 and 104 can be carbon steel pipes.

As illustrated, the controller 120 includes embedded software to control the operation of the bug or automated welding device 110 and the power supply 130.

The automated welding system 100 can allow for mechanized automated welding of pipelines and can be used for mechanized welding of tie-in portions, such as pipeline sections that are disposed under roads, highways, rivers, etc. Advantageously, the automated welding system 100 allows for rapid welding of pipeline joints with less errors and increased safety.

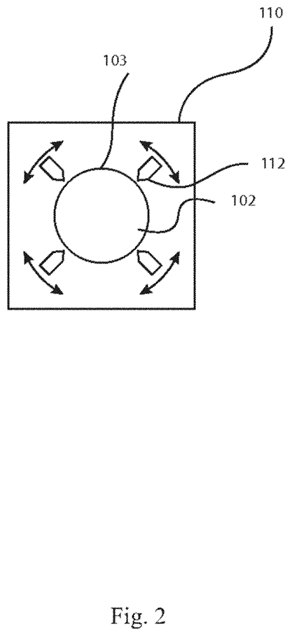

FIG. 2 is a cross-sectional schematic view of the automated welding device 110 of FIG. 1. With reference to FIGS. 1 and 2, the automated welding device 110 can use one or more welding torches 112 to weld a pipe end 103 with an opposing pipe end (not pictured) to form a pipe joint. In the illustrated embodiment, the welding torches 112 can move angularly along the outer surface of the pipes 102 and 104 to weld portions of the pipe joint. The angular motion of the welding torches 112 can be controlled by the controller 120 and can be moved in any suitable pattern.

As can be appreciated, the automated welding device 110 can include any suitable number of welding torches 112. In some embodiments, the welding torches 112 can be modular, allowing for welding torches 112 to be added or removed from the automated welding device 110 as needed.

In some embodiments, each welding torch 112 includes a corresponding power supply 130. During operation, the power supply 130 control the output of the arc of the corresponding welding torch 112. In the depicted example, the controller 120 can control the operation of each power supply 130.

As can be appreciated, the automated welding system 100 can be configured for various applications or requirements. For example, the automated welding system 100 can be configured to various types of welding, such as solid wire welding, flux core welding, and/or metal core welding. Similarly, the automated welding system 100 can be configured for various output rates, including, but not limited to 25 joints per day, 50 joints per day, 100 joints per day. Further, error rate tolerances can be configured.

Optionally, the automated welding system 100 can be configured to be used with a wide range of welding gases. For example, suitable gases can be in the range of 75%-90% Argon and 25%-10% carbon dioxide. In some embodiments, the automated welding system 100 can utilize 90%-100% carbon dioxide.

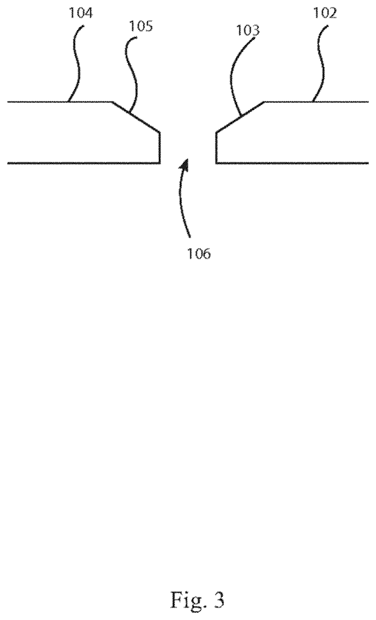

FIG. 3 is a partial cross-sectional view of a pipe joint 106. In some applications, the automated welding system 100 described herein can be utilized to perform a root pass along the pipe joint 106 by controlling the operation of the automated welding device 110. Advantageously, by controlling the operation of the automated welding device 110, the automated welding system 100 can perform the root pass of the pipe joint 106 without migration or dripping of liquefied metal into the pipes 102 and 104, alleviating the need for clamps or copper backing within the pipes 102 and 104. After the root pass, the pipe joint 106 joins the respective ends 103 and 105 of pipes 102 and 104. Optionally, the ends 103 and 105 can be beveled to facilitate fusion across the pipe joint 106.

Prior to operation, a predefined welding process is selected from a library of welding processes. For example, a predefined welding process can be selected that is suitable for the materials, equipment, configuration, environment, and desired results. Optionally, the predefined welding process can control the behavior of the power supply 130 and the respective welding torch 112. By way of example, predefined welding processes can control and stabilize the welding arc to minimize splattering, increase deposition rates, and/or improve the weld or bead quality. In some embodiments, a predefined welding process can control the welding current or welding current waveform based on events such as short circuit conditions. As can be appreciated, predefined welding processes can identify and react to short circuit conditions. During operation, predefined welding processes may reduce current during short circuit conditions to avoid splatter of the weld puddle and can increase current to accelerate metal transfer during other times. Accordingly, such predefined welding processes can control metal transfer and heat generated during welding operations. Examples of predefined welding processes can include but are not limited to Low Spatter Control (LSC) Advanced by Fronius, Surface Tension Transfer (STT) by Lincoln, and/or Regulated Metal Deposition by Miller. Optionally, such a predefined welding process can be selected by the controller 120.

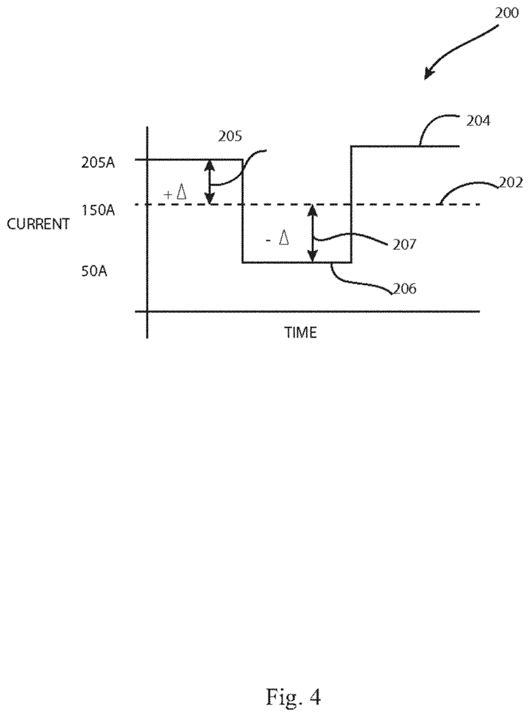

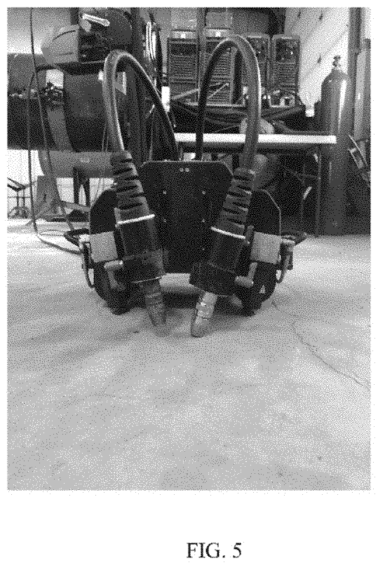

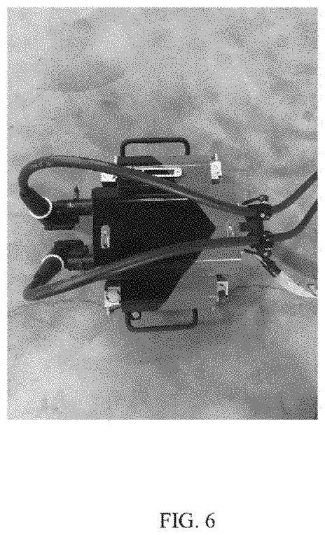

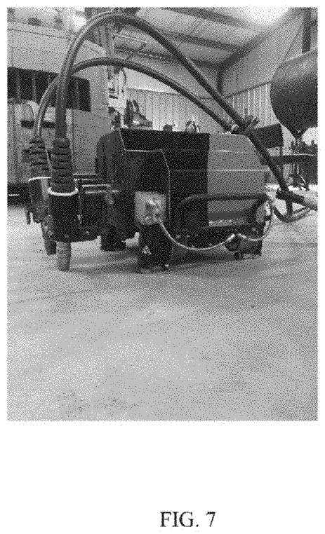

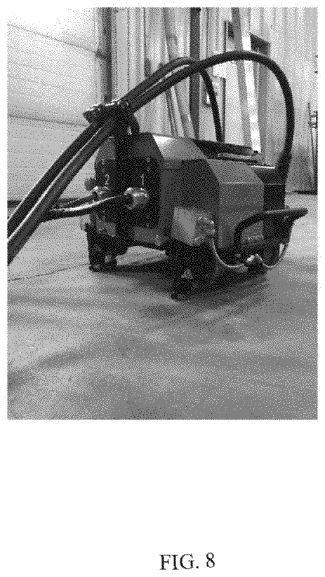

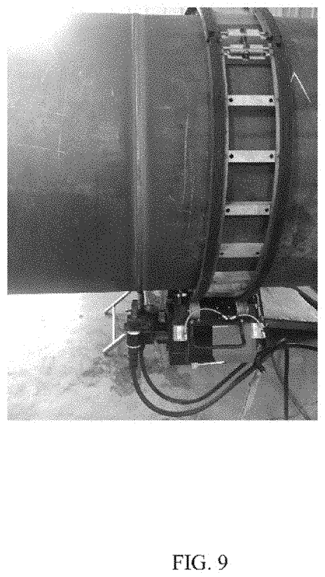

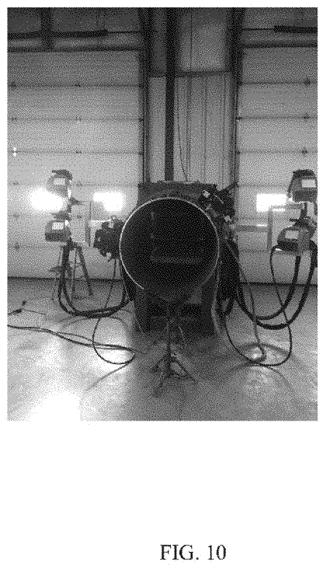

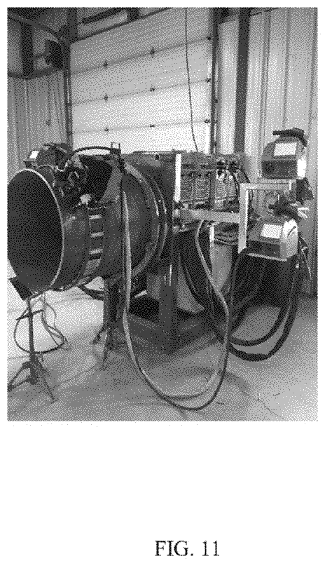

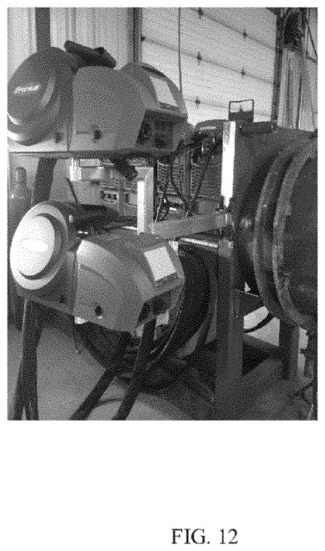

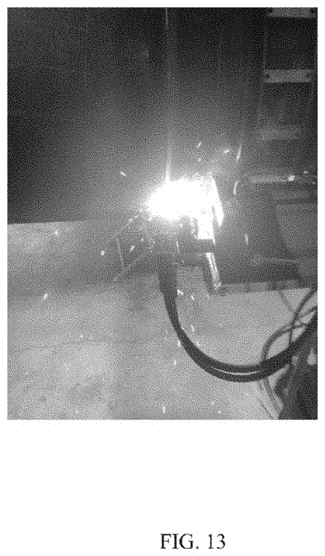

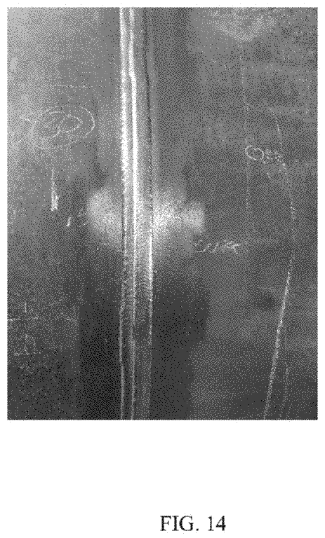

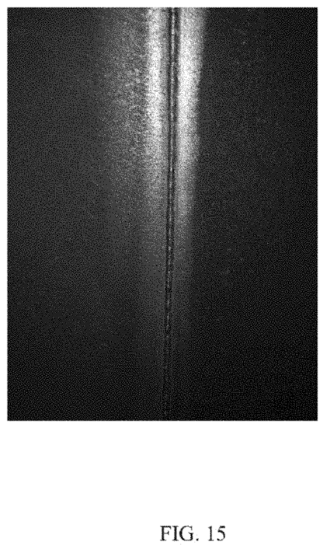

FIG. 4 is a chart illustrating cycling a welding parameter 200. With reference to FIG. 4, the predefined welding process can be overlaid or modified with a secondary welding process as described herein to improve the quality and success of the welding operation. In the depicted example, during operation, one or more welding parameter 200 from the selected predefined welding process can be selected and modified to overlay or modify the selected predefined welding process with the secondary welding process. For example, the secondary welding process can be overlaid such that a selected welding parameter 200 of the predefined welding process can be cycled between a high parameter value and a lower parameter value about a base parameter value, allowing the welding parameter 200 to increase and decrease during the welding operation. For example, the welding parameter 200 can be wire feed speed, voltage, or amperage (as illustrated in FIG. 4) utilized in the predefined welding process. As can be appreciated, the welding parameters 200 may be interlinked such that by cycling one of the welding parameters 200 other welding parameters 200 may vary as a result.

In the depicted example, during the welding operation the predefined welding process can be overlaid such that the amperage can cycle between a maximum or high amperage 204 (as illustrated 250A) and a minimum or low amperage 206 (as illustrated 50A). Optionally, the amperage can oscillate about a base amperage 202 by a positive delta 205 (as illustrated 100A) and/or a negative delta 207 (as illustrated 100A). As can be appreciated, the amperage or any other suitable welding parameter 200 may be cycled or oscillated in this manner, while ensuring that the welding arc is not extinguished during the welding operation. In some embodiments, the frequency of the cycling or oscillation can be varied as needed. Further, in some embodiments, the duty cycle can be varied such that a welding parameter 200 spends the same amount of time in a “high” state and a “low” state, or such that the welding parameter 200 spends a different amount of time in the “high” state and the “low” state.

Advantageously, by overlaying the predefined welding process with the secondary welding process and therefore cycling the welding parameter 200 as described herein, predefined welding processes can be utilized or otherwise adapted to the demands of pipeline welding. In particular, by cycling the welding parameter 200, a procedure not appreciated for carbon steel welding, liquefied metal can have the opportunity to solidify without dripping or migrating away from the pipe joint due to gravity, while ensuring a desired weld quality.

It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

1. A method comprising:
disposing an automated welding device adjacent to a pipe joint formed by clamping a plurality of pipes, wherein the automated welding device is disposed on an outer surface of at least one pipe of the plurality of pipes;
selecting a predefined welding process from a library of welding processes, wherein the predefined welding process is configured to control a welding arc in response to a short circuit condition;
selecting a welding parameter of the predefined welding process;
overlaying the predefined welding process with a secondary welding process by cycling the welding parameter between a high parameter value and a low parameter value about a base parameter value;
welding an open root pass between the plurality of pipes via the automated welding device using the predefined welding process, wherein the welding parameter is cycled between the high parameter value and the low parameter value about the base parameter value; and
maintaining an arc between the automated welding device and the pipe joint during welding.

2. The method of claim 1, wherein welding comprises mechanized automated welding.

3. The method of claim 1, wherein welding comprises mechanized welding of a tie-in joint.

4. The method of claim 1, further comprising adjusting a speed of the cycling of the welding parameter between the high parameter value and the low parameter value about the base parameter value.

5. The method of claim 1, wherein the plurality of pipes comprise a plurality of carbon steel pipes.

6. The method of claim 1, wherein the welding parameter comprises a wire-feed speed.

7. The method of claim 1, wherein the welding parameter comprises a voltage.

8. The method of claim 1, wherein the welding parameter comprises a amperage.

9. The method of claim 1, further comprising welding in an environment comprising between 75%-90% Argon.

10. The method of claim 1, further comprising welding in an environment comprising between 90%-100% carbon dioxide.

11. An apparatus, comprising:
an automated welding device comprising a torch, wherein the automated welding device is configured to be used with at least one of solid wire, flux core, or metal core; and
a controller, wherein the controller is configured to control a welding speed of the automated welding device.

12. The apparatus of claim 11, wherein the torch can comprise a plurality of torches.

13. The apparatus of claim 12, wherein the automated welding device can be configured with a selected quantity of torches of the plurality of torches.
